(19) United States
(12) Patent Application Publication
(10) Pub. No.: US 2019/0226098 A1
(43) Pub. Date: Jul. 25, 2019

(54) Methods And Systems For Production Of Chlorine And Caustic Using Oxygen Depolarized Cathode

(71) Applicants: Dioxide Materials, Inc., Boca Raton, FL (US); 3M Innovative Properties Company, St. Paul, MN (US)

(72) Inventors: Richard I. Masel, Boca Raton, FL (US); Jerry J. Kaczur, North Miami Beach, FL (US)

(21) Appl. No.: 16/252,613

(22) Filed: Jan. 19, 2019

Related U.S. Application Data
(63) Continuation of application No. PCT/US2017/043566, filed on Jul. 24, 2017.
(60) Provisional application No. 62/366,610, filed on Jul. 25, 2016.

(51) Int. Cl. C25B 1/46; C25B 13/08; C25B 9/10; B01J 41/13; B01J 41/14

(52) U.S. Cl. CPC C25B 1/46; C25B 13/08; B01J 41/14; B01J 41/13; C25B 9/10

(57) ABSTRACT

Methods and systems for the production of chlorine and caustic employ a hydroxide-stable anion exchange membrane located against the face of the oxygen depolarized cathode (ODC). The anion exchange membrane contains a polymer including one or more of a phosphonium, a primary, secondary, tertiary or quaternary ammonium, a guanidinium, or a positively charged cyclic amine.

### CROSS-REFERENCE TO RELATED APPLICATIONS

This application is a continuation of international application No. PCT/US2017/043566 filed on Jul. 24, 2017 (published as WO 2018/022530 A1 on Feb. 1, 2018). The '566 international application claims priority benefits, in turn, from U.S. provisional patent application Ser. No. 62/366,610 filed on Jul. 25, 2016, entitled “Methods and Systems for Production of Chlorine and Caustic Using Oxygen Depolarized Cathode”. The '566 international application and the '610 provisional application are each hereby incorporated by reference herein in their entirety.

### FIELD OF THE INVENTION

The present disclosure generally relates to the field of electrochemical reactions, and more particularly to methods and systems for the production of chlorine, caustic and related compounds from alkali metal chlorides such as sodium chloride.

### BACKGROUND OF THE INVENTION

The electrochemical production of chlorine and caustic (sodium hydroxide) is an important industrial process, manufacturing millions of tons of chlorine and caustic annually that are used in making a number of chemicals and fine chemicals. The electrochemical process, typically called the chlor alkali process, consumes a large amount of electrical power. Various improvements have been made over the years in the chlor alkali cell technology in the areas of membranes, electrocatalysts, and cell designs that have resulted in significant power consumption reduction improvements per ton of chlorine and caustic produced. Additional voltage reduction methods that have been worked on over the years have been in the area of modifying the cathode reaction, so that the cathode reaction can occur at a lower voltage (potential) than the typical reaction. This generates hydrogen from the reduction of water at the cathode. One of the most promising technologies is the implementation of an oxygen consuming cathode, also known as an oxygen depolarization cathode (ODC), which utilizes gas diffusion electrode (GDE) structures. See, for example, Moussallem et al “Chlor-Alkali Electrolysis with Oxygen Depolarized Cathodes: History, Present Status and Future Prospects”, J. Appl. Electrochem. 38 (2008) 1177-1194 and Bulan et al. U.S. Patent Application Publication No. 2013/0236797.

The potential use of oxygen in the chlorine cell cathode reaction has been extensively researched over the past thirty years. The oxygen reduction reaction produces hydroxide ions (OH⁻) at the cathode instead of hydrogen, but operates at a much lower cathode half-cell potential. This results in a significant reduction in the chlorine overall cell voltage. The oxygen reduction cathode typically utilizes a gas diffusion electrode (GDE) or cathode to efficiently conduct the reduction of oxygen in the cathode reaction at an electrocatalyst layer on the GDE. The GDE typically includes a gas diffusion layer (GDL) where the gas passes through into the catalyst or electrocatalyst layer (CL). The oxygen reduction reaction occurs in a three phase gas-liquid-solid region in the electrocatalyst layer. Various fabrication methods, such as the introduction of hydrophobic material, such as polytetrafluoroethylene (PTFE), into the electrocatalyst reaction layer have been employed so that the mass transfer of oxygen into the electrocatalyst reaction layer can occur without a liquid, such as water or an NaOH solution, flooding the reaction zone and thus limiting the efficiency of the reaction. The use of nano-sized electrocatalysts has been employed to increase the surface area for the reaction, so that a GDE allows operation of the chlorine cell at high current densities. Some short-term and long-term operation of chlorine cells employing an ODC, in which the ODC can begin to flood due to the loss of hydrophobic properties of the electrocatalyst layer due to aging or the accumulation of impurities in the ODC, have been noted. In addition, the height and total surface area of the electrolyzer can be limited due to issues with hydrostatic pressure pushing liquid back through the gas diffusion layer, again flooding the GDE.

### SUMMARY OF THE INVENTION

Methods and systems for the production of chlorine and caustic employ a hydroxide-stable composition polymeric anion exchange membrane located against the face of the oxygen depolarized cathode (ODC), ensuring that the gas diffusion electrode (GDE) structure does not flood under the liquid hydrostatic pressure of the catholyte compartment. The anion exchange membrane can allow for the transport of hydroxide (OH⁻) ions from the GDE and can allow for the transport of water to the GDE reaction catalyst surface through the membrane. In some embodiments, the oxygen supplied to the GDE can be suitably humidified with water vapor, such that the anion membrane stays sufficiently hydrated.

### BRIEF DESCRIPTION OF THE DRAWINGS

FIG. 1 is a schematic illustrating a system for the electrochemical production of chlorine and caustic utilizing an oxygen depolarized gas diffusion electrode, a cathode side polymeric anion exchange membrane, a center flow compartment, and an anode side cation exchange membrane.

### DETAILED DESCRIPTION OF ILLUSTRATIVE EMBODIMENTS

Any numerical value ranges recited herein include all values from the lower value to the upper value in increments of one unit, provided that there is a separation of at least two units between any lower value and any higher value. As an example, if it is stated that the concentration of a component or value of a process variable such as, for example, size, angle, pressure, time and the like, is, for example, from 1 to 98, specifically from 20 to 80, more specifically from 30 to 70, it is intended that values such as 15 to 85, 22 to 68, 43 to 51, 30 to 32, and the like, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value are to be treated in a similar manner.

### Definitions

The term “polymer electrolyte membrane” refers to both cation exchange membranes, which generally comprise polymers having multiple covalently attached negatively charged groups, and anion exchange membranes, which generally comprise polymers having multiple covalently attached positively charged groups. Typical cation exchange membranes include proton conducting membranes, such as the perfluorosulfonic acid polymer available under the trade designation NAFION from E. I. du Pont de Nemours and Company (DuPont) of Wilmington, Del.

The term “anion exchange polymer” refers to polymers having multiple covalently attached positively charged groups.

The terms “anion exchange membrane” and “anion membrane” as used here refer to membranes comprising polymers having multiple covalently attached positively charged groups.

The term “anion exchange membrane electrolyzer” as used here refers to an electrolyzer with an anion-conducting polymer electrolyte membrane between the anode and the cathode.

The term “imidazolium” as used here refers to a positively charged ligand containing an imidazole group. This includes a bare imidazole or a substituted imidazole. Ligands of the form:

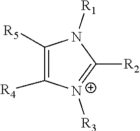

where R₁-R₅ are each independently selected from hydrogen, halogens, linear alkyls, branched alkyls, cyclic alkyls, heteroalkyls, aryls, cyclic aryls, heteroaryls, alkylaryls, heteroalkylaryls, and polymers thereof, such as the vinyl benzyl copolymers described herein, are specifically included.

The term “pyridinium” as used here refers to a positively charged ligand containing a pyridinium group. This includes a protonated bare pyridine or a substituted pyridine or pyridinium. Ligands of the form

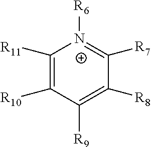

where R₆-R₁₁ are each independently selected from hydrogen, halogens, linear alkyls, branched alkyls, cyclic alkyls, heteroalkyls, aryls, cyclic aryls, heteroaryls, alkylaryls, heteroalkylaryls, and polymers thereof, such as the vinyl benzyl copolymers described herein, are specifically included.

The term “pyrazoliums” as used here refers to a positively charged ligand containing a pyrazolium group. This includes a bare pyrazolium or a substituted pyrazolium. Ligands of the form

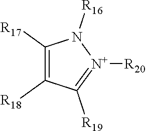

where R₁₆-R₂₀ are each independently selected from hydrogen, halogens, linear alkyls, branched alkyls, cyclic alkyls, heteroalkyls, aryls, cyclicaryls, heteroaryls, alkylaryls, heteroalkylaryls, and polymers thereof, such as the vinyl benzyl copolymers described herein, are specifically included.

The term “phosphonium” as used here refers to a positively charged ligand containing phosphorus. This includes substituted phosphorus. Ligands of the form:

P⁺(R₁₂R₁₃R₁₄R₁₅)

where R₁₂-R₁₅ are each independently selected from hydrogen, halogens, linear alkyls, branched alkyls, cyclic alkyls, heteroalkyls, aryls, cyclic aryls, heteroaryls, alkylaryls, heteroalkylaryls, and polymers thereof, such as the vinyl benzyl copolymers described herein, are specifically included.

The term “guanidinium” as used here as used here refers to a positively charged ligand containing a guanidinium group. This includes a protonated bare guanidine or a substituted guanidine or guanidinium ligand of the form:

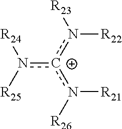

where R₂₁-R₂₆ are each independently selected from hydrogen, halogens, linear alkyls, branched alkyls, cyclic alkyls, heteroalkyls, aryls, cyclic aryls, heteroaryls, alkylaryls, heteroalkylaryls, and polymers thereof, such as the vinyl benzyl copolymers described herein, are specifically included.

The term “positively charged cyclic amine” as used here refers to a positively charged ligand containing a cyclic amine. This specifically includes imidazoliums, pyridiniums, pyrazoliums, pyrrolidiniums, pyrroliums, pyrimidiums, piperidiniums, indoliums, triaziniums, 4-diazabicyclo[2.2.2]octane derivatives and polymers thereof, such as the vinyl benzyl copolymers described herein.

The term “electrochemical device” as used here refers to a device capable of either generating electrical energy from chemical reactions or facilitating chemical reactions through the introduction of electrical energy. Batteries, fuel cells, electrolyzers, and electrochemical reactors are specifically included.

The term “vinyl benzyl derivatives” as used here refers to a chemical of the form.

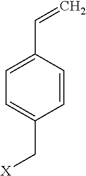

or polymers thereof where X is hydrogen, halogens, linear alkyls, branched alkyls, cyclic alkyls, heteroalkyls, aryls, cyclic aryls, heteroaryls, alkylaryls, heteroalkylaryls, imidazoliums, pyridiniums, pyrazoliums, pyrrolidiniums, pyrroliums, pyrimidiums, piperidiniums, indoliums, or triaziniums. Polymers thereof, such as the vinyl benzyl copolymers described herein, are specifically included.

The term “liquid free cathode” refers to an electrolyzer in which there are no bulk liquids in direct contact with the cathode during electrolysis. There can be a thin liquid film on or in the cathode, however, and an occasional wash, or rehydration of the cathode with liquids can be used or occur.

### Specific Description

Methods and systems for production of chlorine and caustic can involve utilizing an anion membrane in conjunction with a GDE utilizing an oxygen depolarized cathode reaction.

The conventional chlor alkali cell reaction using salt, NaCl, as a feedstock and without the use of an ODC cathode reaction is as follows:

2NaCl+2H₂O→Cl₂+2NaOH+H₂ [1]

The overall cathode and anode reactions and their standard E° potentials are as follows:

Anode: 2Cl⁻→Cl₂+2e⁻ E°=−1.36 V [2]

Cathode: 2H₂O+2e⁻→H₂+2OH⁻ E°=−0.86 V [3]

Net Cell Voltage: E°=−2.19 V [4]

Alternate cathode reaction—oxygen depolarization:

Oxygen Cathode: O₂+4e⁻+2H₂O→4OH⁻ E°=0.40 V [5]

Net Cell Voltage: E°=(−1.36+0.40)=−0.96 V [6]

These reactions show that a potential voltage decrease of −1.23 V is possible using the oxygen reaction at the cathode in place of producing hydrogen.

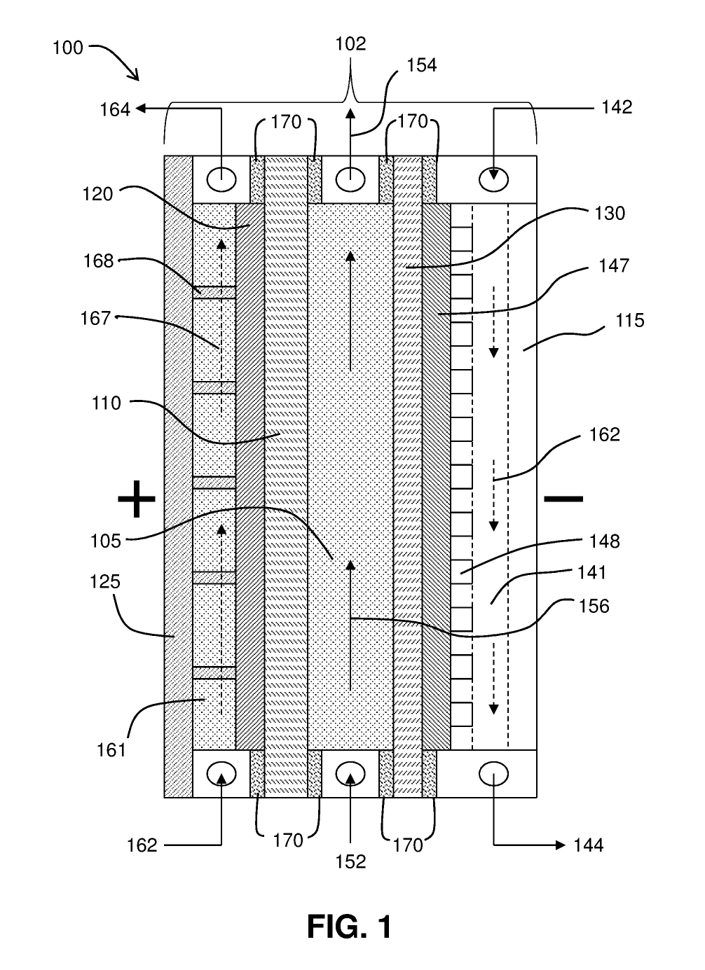

Referring to FIG. 1, a schematic illustrating system 100 for the electrochemical device shown. System 100 shows electrochemical cell 102 which can be configured for the production of chlorine and sodium hydroxide using a sodium chloride feed. System 100 can include an electrochemical cell (also referred as a container, electrolyzer, or cell) 102. Electrochemical cell 102 can be implemented as a divided cell. The divided cell can be a divided electrochemical cell. Electrochemical cell 102 can include three compartments or regions: an anolyte compartment 161, center flow compartment 105, and a cathode compartment 141. In some embodiments, a polymeric cation exchange membrane 110 separates the anode compartment 161 from the cathode compartment 141 and/or an anion exchange membrane 130 separates the cathode compartment 141 from the center flow compartment 105.

Electrochemical cell 102, and other electrochemical cells described herein, use an energy source (not shown) which can generate an electrical potential difference between the anode and the cathode. The electrical potential difference can be a DC voltage. The energy source can also be configured to supply a variable voltage or constant current to electrochemical cell 102 or other electrochemical devices.

The anode compartment 161 can include an anode 120, anode current collector or distributor 125, and an anolyte solution. The anolyte compartment can have ports for a solution and/or gas flow into and out of the anode compartment. In FIG. 1, the anode solution inlet stream is depicted by arrow 162. The anode solution stream flow direction is depicted by arrow 167. The anode solution outlet stream is depicted by arrow 164. The anolyte solution can be a solution containing an alkali metal chloride, such as NaCl. The anolyte solution product discharged through the anolyte solution outlet can include chlorine gas and a depleted NaCl brine solution. As shown in FIG. 1, anode standoffs 168 electrically connect anode 120 to anode current collector 125.

The cathode compartment 141 can include cathode gas GDE 147, cathode current collector or distributor 115, and a cathode solution stream, which in the illustrated embodiment is oxygen. The cathode compartment can have ports for oxygen flow into and out of the cathode compartment 141. In FIG. 1, the oxygen inlet stream is depicted by arrow 142. The oxygen stream flow direction is depicted by arrow 162. The oxygen outlet stream is depicted by arrow 144. FIG. 1 depicts micro-channels or grooves 148 located in cathode compartment conductor 141, where oxygen gas stream 142 enters into cathode GDE 147, where oxygen is electrochemically reduced and exits as a depleted oxygen gas stream 147 from cathode GDE 147. Cathode GDE 147 contains an electrocatalyst that promotes the electroreduction of oxygen. Cathode gas flow plenum 141 in the cathode conductor distributes oxygen gas into the micro-groove channels 148 located at the cathode GDE 147 (see dashed line in the center of the cathode collector 115). Cathode gas flow plenum 141 distributes the oxygen stream into channels 148 and into cathode GDE 147.

The center flow compartment 105 can have ports for center flow compartment solution flow into and out of the center flow compartment 104. In FIG. 1, the center compartment solution inlet stream is depicted by arrow 152. The center compartment solution flow direction is depicted by arrow 156. The center compartment solution outlet stream is depicted by arrow 154.

FIG. 1 also shows the placement of gaskets 170 at the perimeter of electrochemical cell 102 to provide cell compartment sealing.

Cation exchange membrane 110, immediately adjacent to the anode, can selectively control a flow of cations, such as sodium ions, from the anode into the center flow compartment. The cation membrane can preferably be resistant to oxidation, such as a perfluorinated sulfonic acid type membrane. Examples of these membrane types having a fluorinated hydrocarbon backbone are perfluorinated sulfonic acid based cation ion exchange membranes such as those available from DuPont (Wilmington, Del.) under the trade designation NAFION, including the unreinforced types N117 and N120 series, more preferred PTFE fiber reinforced N324 and N424 types, and similar related membranes manufactured by Japanese companies under the supplier trade designations such as FLEMION. Other multi-layer perfluorinated ion exchange membranes used in the chlor alkali industry have a bilayer construction of a sulfonic acid based membrane layer bonded to a carboxylic acid based membrane layer, which efficiently operates with an anolyte and catholyte above a pH of about 2 or higher. These membranes have a much higher anion rejection efficiency. These are sold by DuPont under their trade designation NAFION as the N900 series, such as the N90209, N966, N982, and the 2000 series, such as the N2010, N2020, and N2030 and their types and subtypes.

The center flow compartment can be a region where cations, such as sodium ions, generated in the anode compartment pass through the cation membrane, and can combine with hydroxide ions generated from the cathode compartment to form a sodium hydroxide (caustic) product. In some embodiments, the center flow compartment has solution inlet and outlet ports. The inlet solution can be a weak caustic solution or a concentrated caustic solution produced from recycling the solution to achieve a high concentration. The compartment can contain a filler or spacer to define or maintain the compartment dimensions, such as thickness. The filler materials can be formed from three dimensional materials such as screens, meshes and the like, made from polymeric materials such as caustic stable plastics. Alternatively, polymers can be used such as ion exchange polymers, which can be anion or cation ion exchange type materials. In some preferred embodiments, the flow compartment can be minimal in thickness to reduce the IR drop in the compartment. The flow can be in an upward or downward direction, with a vertical up-flow direction preferred. Deionized water can be added to the center flow compartment to control the NaOH product concentration.

The cathode compartment can include an oxygen consuming GDE cathode, cathode current distributor, a plenum for oxygen distribution, and a gas inlet and depleted gas outlet. The GDE structure can preferable have a catalyst layer (not shown in the drawing) on the side facing the anion exchange membrane and a gas diffusion layer where the oxygen can diffuse to the catalyst region where the oxygen is reduced to hydroxide ions. In some preferred embodiments, the oxygen supplied to the GDE cathode is humidified with water. Various catalysts for the reaction can be used and are well known in the literature. In some embodiments, preferred catalysts are Ag and Ag oxide catalysts and their alloys and mixtures with other metals. Additional metal and oxide catalysts can include nickel, copper, and other transition metals in addition to platinum group metals. The catalyst can be deposited in a thin or thick layer and can be made from a mixture of a non-reactive binder with the catalyst, which can be hydrophobic. The binder can also include an anion exchange polymer. The GDE structure can also contain a metallic wire mesh or screen to allow for good current distribution in the GDE structure. Additionally, metal or other conductive fibers can be added to the binder mix for added conductivity and strength. Metals employed in the GDE and cathode current collector 115 can be comprised of nickel and nickel based alloys. The GDE can also incorporate an Ag or Ag alloy metal screen, and the like. The use of carbon or graphite in the cathode binder mix can be employed, but may not be preferable due to the formation of peroxide radicals in the cathode reactions. Graphene, boron-doped diamond, and other carbon forms can also be useful.

In some preferred embodiments, the anion exchange membrane mounted between the center flow compartment and the cathode GDE can be chemically resistant to alkali metal hydroxides under the operating conditions of the electrochemical cell. The alkali metal hydroxide concentration in the center flow compartment can range from 1 wt % to 50 wt % as NaOH. In some preferred embodiments, the concentration can range 2 wt % to 40 wt %. The anion membrane polymer can be designed to be stable at these concentrations.

The anion exchange membrane can have a layer, deposit, or coating of a selected electrocatalyst on the membrane side facing the GDE cathode. The electrocatalyst can include a micro or nano-particle sized deposit that can use a binder of the same or similar composition as the anion membrane to help bond the particles to the anode surface. The binder can comprise from 0.1 wt % to as much as 30 wt % of the coating layer. The electrocatalyst can be nano-particle sized particles with a composition of Ag and/or AgₓO_{y} as well as alloys with other metals as described in this disclosure. The composition can be the same or different from the electrocatalyst coating layer on the GDE cathode. Additional components can be added to the binder and can include a smaller amount of a neutral or charged hydrophobic or hydrophilic type component that can aid in the promoting the cathode reduction reaction and controlling the performance of the gas-liquid-solid mass transfer reaction interface. Examples of component additions to the binder can include polymers such as PTFE, PVDF, and polyethylene waxes, as well as inorganic particles such as TiO₂, ZnO₂, and the like.

The anion exchange membrane can comprise one or more of phosphoniums, primary, secondary, tertiary or quaternary ammoniums, guanidiniums, or positively charged cyclic amines.

In some preferred embodiments, the anion exchange membranes can contain one or more of imidazoliums, pyridiniums, pyrazoliums, guanidiniums or phosphoniums. In some preferred embodiments, none of the nitrogens in the imidazoliums, pyridiniums, pyrazoliums, or guanidiniums are attached to hydrogen. In some preferred embodiments, all of the ring carbons in said imidazoliums, pyridiniums, or pyrazoliums are attached to CH₃ or CF₃ groups.

The anion exchange membrane can also comprise a polymer comprising one or more of polystyrene, a copolymer of styrene and vinylbenzyl chloride, poly(phenylene oxide), polysulfone, polyethylene, polyetheretherketone, a polyamine, a polyolefin, or a polymer containing phenylene and phenyl groups.

The anion exchange membrane can also be comprised of cross-linking agents.

In some embodiments, a preferred anion exchange membrane is an ion-conducting polymeric membrane comprising a copolymer of styrene and vinylbenzyl-Rₛ, the copolymer forming a polymer blend with at least one constituent selected from the group consisting of:
(a) a linear or substituted polyolefin;
(b) a polymer comprising cyclic amine groups;
(c) a polymer comprising at least one of a phenylene group and a phenyl group;
(d) a polyamide; and
(e) the reaction product of a constituent having two carbon-carbon double bonds,
   wherein Rₛ is an imidazolium and the copolymer contains 10%-90% by weight of vinylbenzyl-Rₛ. In some preferred embodiments, the imidazolium is a tetra-methyl imidazolium or a tetra-fluoromethyl imidazolium.

The anion exchange membrane allows for operation of electrochemical 102 cathode compartment GDE in a liquid free state, where the passage of bulk fluid from the center flow compartment is prevented, or at least reduced, thus allowing long term operation of the GDE in comparison to a GDE that is directly exposed to the bulk fluid flow in the center flow compartment. The anion exchange membrane helps prevent, or at least reduce, the accumulation of unwanted deposits, such as iron and organics, which can occur if exposed to the bulk solution flow. Anion membrane 130 can effectively block trace cation metals present in the anolyte feed and center flow compartment, such as Fe, from depositing onto the GDE. The anion membrane can allow the passage of sufficient water to the GDE reaction surface for the cathode reaction to proceed efficiently. The anion exchange membrane can allow for significant longer term operation of electrochemical cell 102 in comparison to an ODC cell not employing the anion exchange membrane.

### Electrochemical Cell Operating Conditions

Anolyte and catholyte operating temperature can be in a range of 2° C. to 90° C. In some preferred embodiments, the range is 5° C.-85° C. The operating temperature can be limited by the electrolytes used and their solubility and freezing points and the temperature operating limits of the anion membrane employed.

The design of electrochemical cell 102 can include a finite gap or zero-gap configuration in the contact of the anion and cation membranes with the respective cathode and anode. Bipolar stack cell designs and high pressure cell designs can also be employed for the electrochemical cells.

The operating cell voltages for electrochemical cell 102 can range from about 0.5 to about 10 volts depending on the anode and cathode chemistry employed in addition to the cell operating current density. The operating current density of the electrochemical cells can range from 10 mA/cm² to as high as 15,000 mA/cm² or more.

The operating anolyte alkali metal chloride concentration can range from 10 to 300 g/L. In some preferred embodiments, the range is from about 20 to 280 g/L as NaCl. In some preferred embodiments, KCl is another alkali metal chloride for electrochemical cell 102, which can then produce a KOH product in the center flow compartment.

### Optional Anode Chemistries

In other embodiments, the anode chemistry can be such that other alkali metal halides can be employed, such as NaBr, where bromine can be produced. For the bromine and anode oxidation chemistry, carbon and graphite can be suitable for use as anodes. The anode can include electrocatalytic coatings applied to the surfaces of the base anode structure. In the use of NaBr in the anolyte stream, some preferred electrocatalytic coatings can include precious metal oxides such as ruthenium and iridium oxides, as well as platinum and gold and their combinations as metals and oxides on valve metal substrates such as titanium, tantalum, zirconium, or niobium. For bromine and iodine anode chemistry, carbon and graphite are suitable for use as anodes. Polymeric bonded carbon material can also be used. High surface area anode structures that can be used, which would help promote the reactions at the anode surfaces. The high surface area anode base material can be in a reticulated form composed of fibers, sintered powder, sintered screens, and the like, and can be sintered, welded, or mechanically connected to a current distributor back plate that is commonly used in bipolar electrochemical cell assemblies. In addition, the high surface area reticulated anode structure can also contain areas where additional catalysts can be applied on and near the electrocatalytic active surfaces of the anode surface structure to enhance and promote reactions that can occur in the bulk solution away from the anode surface, such as the reaction between bromine and the carbon based reactant, being introduced into the anolyte. The anode structure can be gradated, so that the density of the anode structure material can vary in the vertical or horizontal direction to allow the easier escape of gases from the anode structure. In this gradation, there can be a distribution of particles of materials mixed in the anode structure that can contain catalysts, such as precious metals such as platinum and precious metal oxides such as ruthenium oxide in addition to other transition metal oxide catalysts.

For the anode reaction with the generation of oxygen, electrocatalytic coatings of precious metals, such as platinum, and precious metal oxides such as ruthenium and iridium oxides and their combinations as metals and oxides on valve metal substrates such as titanium, tantalum, or niobium can be suitable. High surface area anode structures can also be used.

In some embodiments, the anolyte can utilize other alkali metal compounds in an anodic chemistry to produce an alternate anolyte product. An example can be the use of sodium sulfite, thus producing SO₂ as an anolyte product in addition to producing co-product NaOH. The anode operating potential can also be significantly lower than that of an oxygen generating anode reaction.

The specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. An electrochemical device for converting an alkali metal chloride to chlorine and the corresponding alkali metal hydroxide, the system comprising:
(a) an anode compartment comprising an anode with a quantity of anode catalyst, said anode having an anode reactant introduced thereto via anode reactant flow channel;
(b) a cathode compartment comprising a liquid free cathode with a quantity of cathode catalyst, said cathode having a cathode reactant introduced thereto via cathode reactant flow channel;
(c) a center flow compartment located between said anode and said cathode compartments, said center flow compartment having an inlet solution feed and an outlet solution product output;
(d) a cation exchange membrane interposed between said anode and said center flow compartment; and
(e) an anion exchange membrane interposed between said cathode and said center flow compartment;
wherein said cathode is encased in a cathode chamber and at least a portion of said cathode catalyst is directly exposed to gaseous oxygen during electrolysis.

2. The device in claim 1, wherein said anion exchange membrane comprises polymers comprising one or more of a phosphonium, a primary, secondary, tertiary or quaternary ammonium, a guanidinium, or a positively charged cyclic amine.

3. The device in claim 2, wherein said anion exchange membrane comprises one or more of polystyrene, a copolymer of styrene and vinylbenzyl chloride, poly(phenylene oxide), polysulfone, polyethylene, polyetheretherketone, a polyamine, a polyolefin, a polymer containing both phenylene and phenyl groups, or a copolymer of styrene and vinylbenzyl-Rₛ, wherein Rₛ is a phosphonium, a primary, secondary, tertiary or quaternary ammonium, a guanidinium, or a positively charged cyclic amine.

4. The device in claim 3, wherein said positively charged cyclic amine comprises at least one of an imidazolium, a pyridinium, or a pyrazolium.

5. The device in claim 4, wherein none of the nitrogen atoms or phosphorus atoms in said imidazolium, pyridinium, pyrazolium, guanidiniums, or phosphonium are attached to hydrogen.

6. The device in claim 5, wherein all of the ring carbons in said imidazolium, pyridinium, or pyrazolium are attached to —CH₃ or —CF₃ groups.

7. The device in claim 5, wherein said anion exchange membrane is an ion-conducting polymeric membrane comprising a copolymer of styrene and vinylbenzyl-Rₛ, said copolymer forming a polymer blend with at least one constituent selected from the group consisting of:
(a) a linear or substituted polyolefin;
(b) a polymer comprising cyclic amine groups;
(c) a polymer comprising at least one of a phenylene group and a phenyl group;
(d) a polyamide; and
(e) the reaction product of a constituent having two carbon-carbon double bonds,
wherein Rₛ is an imidazolium and the copolymer contains 10%-90% by weight of vinylbenzyl-Rₛ.

8. The device of claim 1, wherein said liquid free cathode comprises a gas diffusion electrode cathode construction that does not contact the bulk fluid of the center flow compartment due to the intervening anion exchange membrane.

9. The liquid free cathode of claim 8, wherein when a voltage is applied between said anode and said cathode, oxygen gas is supplied to the cathode reaction with gaseous oxygen and water produces hydroxide ions.

10. The device of claim 7 where said imidazolium comprises one constituent selected from the group of a tetra-methyl imidazolium and a tetra-fluoromethyl imidazolium.

11. The device of claim 7 wherein said anion exchange membrane contains a surface catalyst coating on a face of said anion exchange membrane.

12. The device of claim 11 wherein said catalyst coating consists of at least one of a catalyst composition containing Ag and alloys of Ag containing transition metals and platinum group metals.
